(19) United States
(12) Patent Application Publication
(10) Pub. No.: US 2026/0308493 A1
(43) Pub. Date: Oct. 8, 2026

(54) SYSTEM AND METHOD FOR FLAVOR MATURATION IN FOOD AND BEVERAGES

(71) Applicant: True Essence Foods Inc., Indianapolis, IN (US)

(72) Inventor: Matthew J. RUBIN, Carmel, IN (US)

(21) Appl. No.: 19/637,505

(22) Filed: Apr. 2, 2026

Related U.S. Application Data
(60) Provisional application No. 63/782,568, filed on Apr. 2, 2025.
(60) Provisional application No. 63/801,304, filed on May 7, 2025.

(51) Int. Cl. C12C 11/00; A23L 2/38; A23L 29/00

(52) U.S. Cl. CPC C12C 11/00; A23L 2/382; A23L 29/065

(57) ABSTRACT

The present disclosure provides a system for controlling or adjusting fermentation molecules in a food or beverage. The system can include a leaky vessel, a gas separator in fluid communication with the leaky vessel, at least one of a pressure control or a heating control system, and a controller configured to control at least one of a temperature, a pressure, or a time experienced by the food or beverage in the leaky vessel. The gas separator can be configured to receive the fermentation molecules released from the food or beverage via a gas outlet port and selectively separate the fermentation molecules including a lighter molecular weight from the fermentation molecules including a heavier molecular weight.

### CROSS-REFERENCES TO RELATED APPLICATIONS

This application is based on, claims priority to, and incorporates herein by reference in its entirety, U.S. Provisional Application Ser. No. 63/782,568, filed 2 Apr. 2025, and entitled “SYSTEM AND METHOD FOR FLAVOR MATURATION IN FOODS AND BEVERAGES,” and U.S. Provisional Application Ser. No. 63/801,304, filed 7 May 2025, and entitled “SYSTEM AND METHOD FOR FLAVOR MATURATION IN FOODS AND BEVERAGES.”

### STATEMENT REGARDING FEDERALLY SPONSORED RESEARCH

N/A

### BACKGROUND

As the means for sustaining human life, food and beverage is unique. Though composed of molecules and prepared using processes such as mixing or heating, food care and preparation is generally not treated as chemistry or chemical processing, but an art. This is understandable given that eating and drinking are an exercise of human enjoyment and not a utilitarian exercise in chemical sustenance.

Nevertheless, some common food preparation processes incorporate complex chemical processes. As but just one non-limiting example, fermentation is a complex biochemical process of breaking down a substance using bacteria, yeast, or other microorganisms, through the action of enzymes. In one example, fermentation can be used to convert sugars to ethyl alcohol.

Though food preparation and processing are designed to yield some desired final product, undesirable characteristics or byproducts can also be created. Fermented beverages are complex solutions and suspensions of often tens to hundreds of molecules. Even highly distilled spirits contain multiple organic molecules that interact to create a complex flavor profile. Over time, these molecules in these complex solutions will react with each other and with the environment to alter the chemical profile in such a way that is often considered to enhance the flavor profile.

Thus, many food processing systems and techniques have been designed to control the underlying process, such as fermentation, to produce desirable compounds and avoid creating undesirable characteristics. Others have sought to attempt to remove undesired aspects of a food or beverage that has reached a semi-final product. For example, many distilled liquors are filtered and refiltered to refine the liquor, often, with the goal of creating a “smoother” product with less “bite.” However, even at large commercial scales, the processes are more art than science. That is, the liquor or other food or beverage is filtered or processed multiple times and may also be stored in wood casks, clay pots or other permeable or non-permeable and reactive or non-reactive containers for long periods of time until the discerning pallet determines that the product is desirable.

While these processes and techniques can be used to create exceptional products, they leave room for wide variability in products, particularly, in highly complex foods or beverages and may take long periods of time, varying from a few days to tens of years in storage casks. For example, as discussed above, fermentation is an example of one common, yet highly complex bio-chemical process, which can yield wildly different end products by changing just a few input or processing variables.

With this in mind, low-pressure processing has been used to enhance the flavor profile by selectively removing ethyl acetate and other undesirable aromatic molecules from fermented beverages such as beer, wine, spirits (e.g., brown spirits, aged spirits, new make spirits, etc.), vinegar, kombucha, and the like and beverages made from fermented products, such as brewed coffee and tea and the like. In this process, liquid is introduced into a carefully controlled partial vacuum chamber for a few seconds resulting in the release of ethyl acetate and other light aromatic molecules. Once processed, the liquid is collected at the bottom of the chamber and pumped back to atmospheric pressure. Similar batch processing may be utilized with a particular hold time in the range of 1 to 60 seconds at the desired vacuum pressure. While low-pressure processing of fermented beverages is effective in removing ethyl acetate and other undesirable congeners, it often results in distorted flavor profiles that may taste “thin” or “artificial” to a consumer and has not achieved an even maturation profile. Any distortion of the organoleptic and olfactory map of a beverage often results in an unfamiliar taste to a consumer.

Thus, there is a continuing need for processing foods and beverages to allow for selective manipulation or control of the molecular profile of the food or beverage even after the food or beverage has been through a complex process and/or includes a complex molecular profile, such as including “fermentation molecules.” Specifically, there is a need for systems and methods that can achieve well-balanced and evenly matured foods and beverages without the limitations of current low-pressure processing techniques.

### SUMMARY

The present disclosure overcomes the aforementioned drawbacks by providing systems and methods that empower the selective manipulation of a molecular profile of a food or beverage after it has been at least partially prepared, even using complex processes, such as fermentation, or including complex molecular profiles, such as including fermentation molecules.

In accordance with one aspect of the present disclosure, a system is provided for controlling or adjusting fermentation molecules in a food or beverage. The system can include a leaky vessel that is configured to receive the food or beverage including fermentation molecules. A gas separator can be in fluid communication with the leaky vessel and configured to receive the fermentation molecules released from the food or beverage via a gas outlet port and selectively separate the fermentation molecules including a lighter molecular weight from the fermentation molecules including a heavier molecular weight. At least one of a pressure control or a heating control system can be configured to change environmental parameters in the leaky vessel. A controller can be configured to control at least one of a temperature, a pressure, or a time experienced by the food or beverage in the leaky vessel to selectively control or adjust at least one of an amount or balance of the fermentation molecules in the food or beverage.

In accordance with another aspect of the present disclosure, a method is provided for controlling or adjusting fermentation molecules in a food or beverage. The food or beverage can be positioned in a vessel. A leak rate of the vessel can be controlled to subject the food or beverage to a saturated vapor space within the vessel. At least one of a pressure or temperature experienced by the food or beverage in the vessel can be controlled to selectively control or adjust at least one of an amount or balance of fermentation molecules in the food or beverage and achieve the food or beverage having processed fermentation molecules.

In accordance with another aspect of the present disclosure, a system is provided for controlling or adjusting fermentation molecules in a food or beverage. A plurality of leaky vessels can be provided to receive the food or beverage. A sparger can be configured to provide a compressed gas to the food or beverage. At least one of a pressure control or a heating control system can be configured to change environmental parameters in the plurality of leaky vessels. A controller can be configured to control at least one of a temperature, a pressure, or a time experienced by the food or beverage in the plurality of leaky vessels to selectively control or adjust at least one of an amount or balance of fermentation molecules in the food or beverage.

The foregoing and other aspects and advantages of the disclosure will appear from the following description. In the description, reference is made to the accompanying drawings which form a part hereof, and in which there is shown by way of illustration a preferred configuration of the disclosure. Such configuration does not necessarily represent the full scope of the disclosure, however, and reference is made therefore to the claims and herein for interpreting the scope of the disclosure.

### BRIEF DESCRIPTION OF THE DRAWINGS

The disclosed technology will be better understood and features, aspects and advantages other than those set forth above will become apparent when consideration is given to the following detailed description thereof. Such detailed description makes reference to the following drawings.

FIG. 1 is a block diagram of a non-limiting, example food processing system in accordance with some aspects of the present disclosure.

FIG. 2 is a schematic diagram of a food processing system in accordance with the present disclosure.

FIG. 3 is a flowchart of non-limiting, example steps for a process in accordance with the present disclosure.

FIG. 4 is a plot of concentration of processed molecules in an example beverage including fermentation molecules obtained from experimental data.

FIG. 5 is a plot of concentration of processed molecules in the example beverage of FIG. 4 including fermentation molecules obtained from experimental data.

FIG. 6 is a detailed view of the plot of FIG. 5.

FIG. 7 is a plot of concentration of processed molecules in the example beverage of FIG. 4 including fermentation molecules obtained from experimental data.

FIG. 8 is a detailed view of the plot of FIG. 7.

FIG. 9 is a detailed view of the plot of FIG. 7.

FIG. 10 is a set of graphs showing concentration of dissolved oxygen gas in a food processing system based on different sparging conditions in accordance with the present disclosure.

FIG. 11 is a schematic diagram of a food processing system in accordance with the present disclosure.

FIG. 12 is a schematic diagram of a food processing system in accordance with the present disclosure.

FIG. 13 is a schematic diagram of a food processing system in accordance with the present disclosure.

FIG. 14 is a schematic diagram of a food processing system in accordance with the present disclosure.

FIG. 15 is a schematic diagram of a food processing system in accordance with the present disclosure.

### DETAILED DESCRIPTION

The present disclosure provides systems and methods for the selective manipulation of a molecular profile of a food or beverage after it has been at least partially prepared, even using complex processes, such as fermentation, or including complex molecular profiles, such as including “fermentation molecules.” As used herein, “fermentation molecules” refers to molecules that are often found after a fermentation processes, whether directly after or after secondary processes, including aging, following fermentation. However, as used herein, food including such fermentation molecules do not need to have been subject to or part of a fermentation process.

As used herein, “flavor maturation” refers to the process by which the molecular profile of a food or beverage evolves over time, resulting in changes to its organoleptic and olfactory characteristics. Flavor maturation can depend on the balance of gases dissolved within the food or beverage matrix, which influences the interaction between flavor compounds. In fermented or aged products, the gas balance-particularly the ratio of dissolved oxygen, carbon dioxide, nitrogen, and other gases-fundamentally determines how flavor compounds develop and interact. When gas balance is suboptimal, undesirable flavor compounds may dominate, while proper gas equilibrium promotes harmonious flavor development. Flavor maturation also affects the total concentration and relative ratio of the different fermentation molecules to each other. The exposure of food and beverages to a low-pressure environment under controlled conditions leads to reduction in the concentration of certain fermentation molecules and shifts in the ratio of the remaining fermentation molecules to develop desirable flavor profiles that may otherwise take a very long time to develop. The present disclosure provides systems, methods, manufactured implementations, and other implementations for food or beverage preparation or processing.

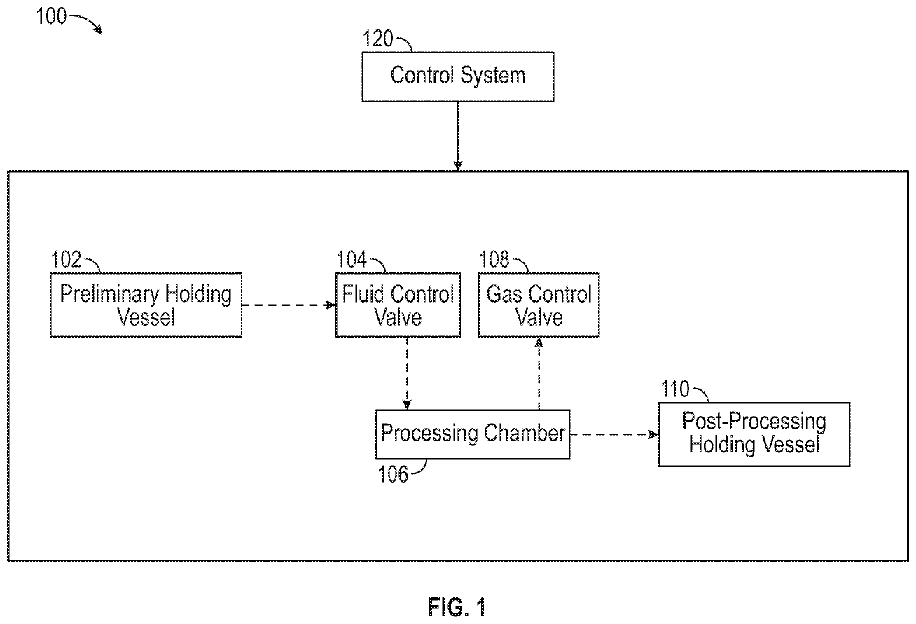

FIG. 1 illustrates an example food processing system 100 according to one configuration of the present disclosure. The food processing system 100 can be used to process a food or beverage that includes fermentation molecules by selectively increasing a concentration of congeners in the food or beverage, for example, at a faster rate than conventional food processing systems. In particular, the food processing system 100 can include a plurality of substrates, vessels and valves that are selectively controlled to produce a food or beverage with an improved flavor profile.

For example, a preliminary holding vessel 102 can be provided to hold a food or beverage to be processed. In some configurations, the preliminary holding vessel 102 can be provided at a predetermined temperature or pressure. For example, beverages can be stored at an atmospheric pressure. In some configurations, a fluid control valve 104 can be provided at an outlet of the preliminary holding vessel 102 to direct a flow of beverages to a downstream system. The fluid control valve 104 can operate to control the flow of beverages out of the preliminary holding vessel 102. In some configurations, the fluid control valve 104 can selectively open or close to permit the flow to a processing chamber 106 for food processing. For example, an opening area of the fluid control valve 104 can be controlled to direct a flow of beverages at a desired flowrate, temperature, or pressure. The fluid control valve 104 can open intermittently or periodically to direct a desired volume of beverages to the processing chamber 106. In some configurations, the preliminary holding vessel 102 can be in a fluid communication with devices (e.g., a pump) to receive a flow of beverages or propel a flow of beverages to a downstream system. In some configurations, the fluid control valve 104 can be connected to a sprayer or a nozzle that can spray the beverages into processing chamber 106. In some configurations, the fluid control valve 104 can be an opening or a tube that directs a stream of beverages to flow into the processing chamber 106.

With continued reference to FIG. 1, the processing chamber 106 can be provided to perform flavor maturation of beverages. For example, the processing chamber 106 can be in pneumatic communication with a pressure source to provide negative pressure to beverages within an internal volume of the processing chamber 106. Correspondingly, a quantity of desired congeners can be enhanced, or a quantity of unwanted congeners can be removed from beverages by establishing a partial vacuum within the processing chamber 106. In some configurations, the pressure source can include a variable displacement pump, a fixed displacement pump, a blower, etc.

In some configurations, the internal volume of the processing chamber 106 can be maintained above a desired or predetermined pressure value. For example, pressure within the processing chamber 106 may be decreased without substantially altering compositions of beverages prior to entering the internal volume of the processing chamber 106. In some configurations, an inlet of the processing chamber 106 can be maintained at pressures such as 760 Torr, 700 Torr, 500 Torr, 400 Torr, 200 Torr, 100 Torr, 50 Torr, 20 Torr, 5 Torr, or the like. The internal volume of the processing chamber 106 can be maintained at pressures such as 550 Torr, 500 Torr, 450 Torr, 400 Torr, 350 Torr, 300 Torr, 250 Torr, 200 Torr, 150 Torr, 100 Torr, 50 Torr, 20 Torr, 5 Torr or the like. In some configurations, the processing chamber 106 can be maintained at a pressure, for example, from 150 Torr to 550 Torr, from 200 Torr to 500 Torr, from 250 Torr to 500 Torr, or from 20 Torr to 100 Torr. In some configurations, the processing chamber 106 can be maintained at a pressure that is selected based on the percent alcohol by volume (ABV) of the starting alcohol composition. For example, the processing chamber 106 may be maintained at a pressure of 150 Torr to 500 Torr for a 50% or higher alcohol by volume (ABV) alcohol composition, at a pressure of from 200 Torr to 450 Torr for a 40% ABV alcohol composition, at a pressure of from 150 Torr to 400 Torr for a 30% ABV alcohol composition, at a pressure of from 150 Torr to 350 Torr for a 20% ABV alcohol composition, or at a pressure of from 150 Torr to 350 Torr for a 1% to 20% ABV alcohol composition.

In some configurations, an additional processing chamber may be provided to gradually step the pressure of the liquid down prior to entering the processing chamber 106. In some configurations, the additional processing chamber may be maintained above a desired range or value. In one non-limiting example, the value may be above intermediate pressures such as 700 Torr, 500 Torr, 400 Torr, 200 Torr or the like.

In some configurations, the temperature of the beverage in the processing chamber 106 may be maintained at a desired value. In one non-limiting configuration, the temperature may be selected from −20 degrees Celsius to 80 degrees Celsius, such as from 0 degrees Celsius to 60 degrees Celsius, from 10 degrees Celsius to 35 degrees Celsius, 20 degrees Celsius to 30 degrees Celsius, or 20 degrees Celsius to 25 degrees Celsius. For example, in some configurations, the temperature of the beverage in the processing chamber 106 may be 21 degrees Celsius, 22 degrees Celsius, 23 degrees Celsius, 24 degrees Celsius, or 25 degrees Celsius.

In some configurations, the temperature of the processing chamber 106 can be maintained at, for example, from −20 degrees Celsius to 70 degrees Celsius, such as from 0 degrees Celsius to 60 degrees Celsius, from 10 degrees Celsius to 35 degrees Celsius, 20 degrees Celsius to 30 degrees Celsius, or 20 degrees Celsius to 25 degrees Celsius. For example, in some configurations, the temperature of the processing chamber 106 may be 21 degrees Celsius, 22 degrees Celsius, 23 degrees Celsius, 24 degrees Celsius, or 25 degrees Celsius. In some configurations, the temperature of the processing chamber 106 can be maintained (e.g., at any of the foregoing temperatures) using a jacket or like temperature controller at least partially enveloping the pressure chamber and in thermal communication with the processing chamber 106. In some configurations, a water jacket can be provided. In some configurations, the temperature of the beverages in the processing chamber 106 can be the same as the temperature at which the processing chamber 106 is maintained. In some configurations, the temperature of the beverage in the processing chamber 106 can be different from the temperature at which the processing chamber 106 is maintained. Thus, in some configurations, a temperature gradient may exist between the temperature of the processing chamber 106 (e.g., the temperature in the jacket or like temperature controller) and the temperature of the beverage in the processing chamber 106.

Referring to FIG. 1, beverages can accumulate within the internal volume of the processing chamber 106 as a flow of beverages passes through the fluid control valve 104. The accumulated volume of beverages can be processed by subjecting the beverages to the negative pressure over a period of time. In some configurations, the processing chamber 106 can include an inner wall with a path, such that the flow of beverages can be subject to the negative pressure as the flow travels down the path along the inner wall. For example, the inner wall can be smooth, polished, etched, or roughened to promote an evolution of bubbles in beverages. In some configurations, the processing chamber 106 can include a stack of trays that a flow of beverages can cascade downward. While the present configuration includes one processing chamber 106, a greater number of processing chambers (e.g., two, three, four, five, etc.) can be provided in other configurations.

Continuing, an outlet of the processing chamber 106 can include a gas control valve 108 that is in pneumatic communication with the processing chamber 106. In some examples, the gas control valve 108 can process the removed congeners from the processed beverages (e.g., flavor-matured beverages) within the internal volume of the processing chamber 106. For example, the gas control valve 108 can vent the removed congeners to surroundings or capture the removed congeners to be reprocessed for other systems of the food processing system 100. In some configurations, the gas control valve 108 can vent a specific type or composition of congeners from the processing chamber 106. In some configurations, the gas control valve 108 can vent pressurized air within the processing chamber 106 (e.g., to control a pressure condition within the processing chamber 106 with greater flexibility).

Further, the food processing system 100 can include a post-processing holding vessel 110 that receives processed beverages from the processing chamber 106. In some configurations, an outlet valve can be provided at an outlet of the processing chamber 106 to discharge a flow of processed beverages to the post-processing holding vessel 110. In some configurations, a pressure source (e.g., a pump) can be provided to pump the processed beverages from the processing chamber 106 to the post-processing holding vessel 110. In some configurations, the processing chamber 106 can include a throughput of about 0.025 liters/minute to about 1.0 liters/minute per liter of the volume of the processing chamber 106, or about 0.1 liters/minute to about 0.8 liters/minute per liter of the volume of the processing chamber 106, or about 0.25 liters/minute to about 0.6 liters/minute per liter of the volume of the processing chamber 106.

With continued reference to FIG. 1, a control system 120 can be provided to engage with various components of the food processing system 100 to perform various tasks, including controlling or adjusting fermentation molecules in beverages. For example, the control system 120 can control an operation of the fluid control valve 104, the gas control valve 108, the preliminary holding vessel 102, the processing chamber 106, or the post-processing holding vessel 110. In particular, the one or more of the components of the food processing system 100 can be provided with one or more sensors that measure various parameters, including humidity, pressure, temperature, flow rate, density, etc. The control system 120 can be in an electronic communication with the one or more sensors to receive control signals and control operating parameters of the one or more of the components of the food processing system 100. In some examples, the control system 120 can receive an operator input to control various components of the food processing system 100. In some cases, the control system 120 can be operated according to a control logic or a control algorithm.

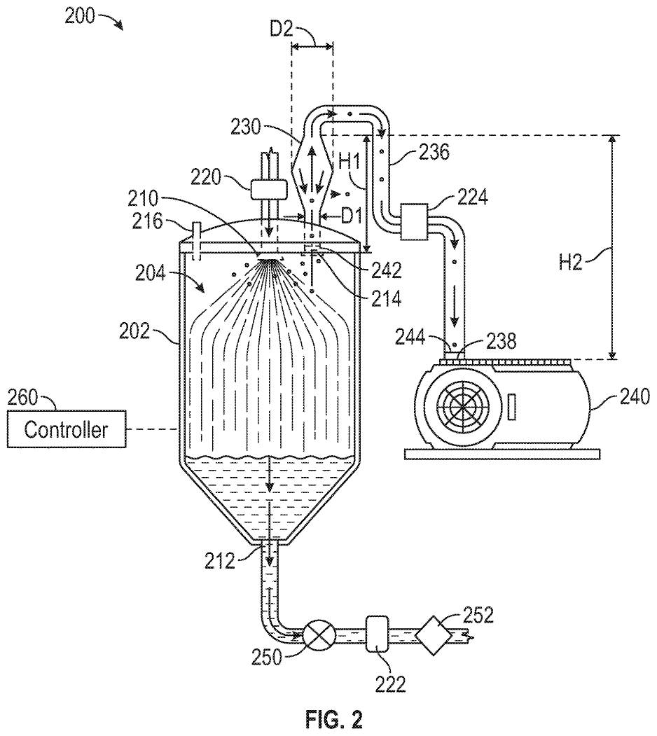

FIG. 2 illustrates a non-limiting food processing system 200 for processing beverages including, as just one example, fermentation molecules. The food processing system 200 is a particular example of the food processing system 100 of FIG. 1 and includes aspects that are similar to the food processing system 100 of FIG. 1. However, in some aspects, the food processing system 100 and the food processing system 200 differ, including regarding a configuration of downstream systems of the vessel 202.

In particular, the vessel 202 (e.g., a processing chamber) includes an internal volume 204. The vessel 202 can receive a food or beverage to be processed within the internal volume 204. The vessel 202 includes a fluid inlet 210 that routes the food or beverage into the internal volume 204. In the illustrated example, the fluid inlet 210 is positioned at an upper portion of the vessel 202. A plurality of valves (e.g., similar to the fluid control valve 104 of FIG. 1) can be provided to control opening and closing of the fluid inlet 210. In some configurations, the fluid inlet 210 may be configured to introduce the food or beverage in various ways to increase an exposed surface area of the food or beverage relative to the internal volume 204. For example, the fluid inlet 210 can be configured for spraying the food or beverage (e.g., via a spray nozzle), percolating the food or beverage, or directing the food or beverage onto a plurality of sequential trays that is angularly positioned within internal volume 204. In particular, the plurality of trays can extend from the upper portion of the vessel 202 to a lower portion of the vessel 202, such that the food or beverage flows downward through the internal volume 204 (e.g., in a back-and-forth waterfall pattern). In some configurations, a high surface area of the food or beverage can enhance the interaction between the food or beverage and the pressurized environment within the vessel 202. Further, the vessel 202 includes a fluid outlet 212 that routes processed food or beverage from the internal volume 204 to a downstream system. In some configurations, the fluid outlet 212 may be provided at a lower portion of the vessel 202.

Referring to FIG. 2, the vessel 202 can operate at a predetermined pressure value. For example, the pressure value of the vessel 202 can be between about 5 Torr and about 600 Torr, between about 10 Torr and about 200 Torr, between about 20 Torr and about 100 Torr, between about 150 Torr and about 450 Torr, between about 300 Torr and about 550 Torr, or between about 350 Torr and about 500 Torr or the like. Further, in some configurations, the vessel 202 can operate at a predetermined temperature value. For example, the temperature value of the vessel 202 can be between about 10° C. and about 30° C. In some configurations, the predetermined temperature value can be independent of one or more parameters of the food processing system 200, including the predetermined pressure value. In some configurations, vessel 202 can be maintained at a pressure that is selected based on the percent alcohol by volume (ABV) of the starting alcohol composition. For example, the ABV composition of the starting alcohol composition can be at least 3%, at least 5%, at least 10%, at least 20%, at least 30%, at least 50%, at least 60%, at least 70%, or at least 80%. In some configurations, one or more of the operational parameters including a pressure, a temperature, a flow rate of a food or beverage, a time experienced by the food or beverage in the vessel 202, etc. can be controlled via a controller 260.

In the illustrated configuration, the vessel 202 also includes a gas outlet 214. As the food or beverage is processed within the vessel 202, fermentation molecules are released from the food or beverage into the internal volume 204 and can be exhausted through the gas outlet 214. A plurality of valves (e.g., similar to the gas control valve 108 of FIG. 1) can be provided to control opening and closing of the gas outlet 214. In some configurations, a gas separator 230 can be located at the gas outlet 214. The gas separator 230 can be in fluid or operational communication with the gas outlet 214. In the illustrated configuration, the gas separator 230 includes a vertical rise pipe and extends upwardly from the vessel 202. The gas separator 230 can be configured as a bellow, an expansion chamber, or a diffusion chamber that separate various molecules (e.g., molecules with different molecular weights) within the internal volume 204. In some configurations, the gas separator 230 can separate the molecules within a saturated head space of the internal volume 204.

With continued reference to FIG. 2, the gas separator 230 includes a series of converging and diverging sections that extend between, for example, a diameter D1 (e.g., a minimum diameter) and a diameter D2 (e.g., a maximum diameter). In particular, the gas separator 230 can diverge away from the gas outlet 214 and converge toward an upper portion of the gas separator 230. Put differently, a diameter of the gas separator 230 can increase from the diameter D1 to the diameter D2 and subsequently decrease from the diameter D2 to the diameter D1 (or another dimeter). In some configurations, the ratio of the diameter D2 to the diameter D1 can range between about 1.5 and about 5, or between about 2 and about 4. While the illustrated configurations show the diameter D2 that is greater than the diameter D1, in other configurations, the diameter D2 can be smaller than the diameter D1, or the diameter D1 and the diameter D2 can be substantially similar to one another. Further, the gas separator 230 includes a height H1. In some configurations, the height H1 can be between about 2 inches and about 36 inches, or between about 5 inches and about 24 inches, or between about 10 inches and about 20 inches. In some configurations, the height H1 can be at least 5 inches, at least 8 inches, at least 10 inches, or at least 12 inches. Furthermore, the height H1 and the diameters D1 and D2 can be selected in combination to create, for example, desired ratios of dimensions.

In some configurations, the gas separator 230 can include a uniform cross-sectional shape along the height H1 of the gas separator 230. Further, in some configurations, the cross-sectional shape of the gas separator 230 can include square, rectangle, polygon, oval, or other types of regular or irregular shapes. In some configurations, the diameter of the gas separator 230 changes non-continuously along the height H1. In some configurations, one or more dimensions of the gas separator 230, including the diameter D1, the diameter D2, and the height H1, can be associated with a desired separation of the molecules within the internal volume 204 or a desired flavor profile of a food or beverage. Further, while the illustrated configuration shows one gas separator 230, other configurations can include more than one gas separator, including two, three, four, five, etc. gas separators.

Referring to FIG. 2, the gas separator 230 can be connected to an exhaust manifold 236 at an upper portion of the gas separator 230. The exhaust manifold 236 can include an exhaust port 238 that is connected to an exhaust fan 240. A plurality of valves can be provided to control opening and closing of the exhaust port 238 or to provide a desired level of partial vacuum in the vessel 202. For example, a valve 234 can include a pressure control valve in fluid or operative communication with one or more of the exhaust manifold 236, the gas separator 230, the internal volume 204, and the exhaust fan 240 to selectively provide a desired level of partial vacuum. The exhaust manifold 236 can extend between the upper portion of the gas separator 230 and the exhaust fan 240. The exhaust fan 240 can provide a pressure differential to induce a flow of gas toward the exhaust port 238 from upstream systems (e.g., the internal volume 204, the gas separator 230, or the exhaust manifold 236). In some configurations, the exhaust manifold 236 can include one or more bends to connect the gas separator 230 to the exhaust fan 240. In some configurations, the exhaust manifold 236 can provide a substantially downward drop toward the exhaust port 238. The exhaust manifold 236 can be defined by a height H2 in a linear direction from the upper portion of the gas separator 230 to the exhaust fan 240. In the illustrated configurations, the height H2 is greater than the height H1. In other configurations, the height H2 may be shorter than the height H1 or substantially similar to the height H1.

As shown in FIG. 2, the food processing system 200 can include a plurality of filters along a gas flow path, for example, to enhance diffusion of exhaust gas molecules. For example, a gas outlet filter 242 can be positioned near the lower portion of the gas separator 230, more specifically, at the gas outlet 214. In some configurations, the gas outlet filter 242 can prevent air convection into the internal volume 204. An exhaust port filter 244 can be positioned near the exhaust port 238. In some configurations, the exhaust port filter 244 can prevent formation of convection currents (e.g., due to operation of an exhaust valve for the exhaust port 238). One or more of the gas outlet filter 242 and the exhaust port filter 244 can include various materials, such as porous membranes, mesh screens (e.g., sanitary mesh screens), or other structures that allow for selective passage of gases. In some configurations, mesh size of the gas outlet filter 242 or the exhaust port filter 244 can be associated with desired molecules to separate. In some configurations, the gas outlet filter 242 or the exhaust port filter 244 may be designed to be removable and replaceable, allowing for maintenance and optimization of the separation process based on the specific requirements of different food or beverage products being processed.

In some implementations, a vent valve 216 (e.g., a vent control valve or a leaky valve) may be periodically operated under open loop control to regulate the vacuum atmospheric makeup during continuous operation. Under continuous operation, minute (e.g., small) changes in the atmospheric makeup may shift the relative evaporation rate of minute (e.g., light) congeners; thereby gradually shifting the flavor profile over time during steady state operation. To achieve fresh vacuum atmosphere, the vessel 202 can be configured as a ‘leaky’ vessel by placing the vent valve 216 (e.g., a needle valve, etc.) in operational communication with the vessel 202 and an atmospheric source, such as air or an inert atmosphere. In some implementations, a small vent valve may be placed on a port separate from the vacuum port to enable the vessel 202 to act as the manifold, supporting the air to be replaced across the (entire) vessel 202 rather than the pressure regulator manifold. The vent valve 216 may be opened to a (precise) level to gradually vent gas to the vessel 202, which can result in operation of at least one vacuum control valve, and thereby result in steady state evacuation and atmospheric renewal in the vessel 202 under reduced pressure conditions.

In some configurations, the atmosphere of the vessel 202 can be replaced in average volume once every ten minutes, more typically once every five minutes, still more typically once every two minutes, still more typically once every minute, and still more typically every thirty seconds. The vent valve 216 may also be simulated through PID control by regulating a duty cycle of the vent valve 216 under open loop conditions. Accordingly, the vacuum loop can respond to regulate the pressure, typically on the high side of the setpoint. In some configurations, the duty cycle of the vent valve 216 may achieve similar quasi-steady state operation by periodically opening to enable atmosphere to enter the vessel 202. The periods may be less than a 30% duty cycle, more typically less than a 20% duty cycle, still more typically less than a 15% duty cycle, yet more typically less than a 10% duty cycle, still more typically less than a 5% duty cycle, yet more typically less than a 2% duty cycle, and yet more typically less than a 1% duty cycle. Operational periods maybe less than 3 seconds, more typically less than 1 second, yet more typically less than 0.5 seconds, still more typically less than 0.25 seconds, and still more typically less than 0.15 seconds. Periodic control may similarly replace the atmosphere of the vessel 202, such that one vessel worth of atmosphere at the desired vessel pressure can enter the vessel 202 during the period of time, at least once every ten minutes, more typically every five minutes, still more typically every two minutes, still more typically every minute, and still more typically every thirty seconds.

In some configurations, the vessel 202 can be operated continuously (e.g., without venting), and a desired level of pressure within the vessel 202 can be maintained through a vacuum control. During operation, when the food or beverage is subject to partial pressure, molecules can evaporate from the food or beverage and contribute to the vapor pressure within the vessel 202. In some configurations, evaporation of the molecules can cause the pressure within the vessel 202 to increase. In some configurations, the level of pressure within the vessel 202 can be controlled by periodic, controlled vacuum at the exhaust port 238.

In some configurations, the vessel 202 can be configured to leak at a reduced leak rate (e.g., a vent rate). For example, a composition of the exhaust gas (e.g., routed to the exhaust port 238) can include vent gas that is less than 20% of the composition of the exhaust gas, less than 15%, less than 10%, less than 5%, or between 0.1-3%. In some configurations, a vapor space (e.g., a head space) of the internal volume 204 can be saturated when less than 20% of the exhaust gas is from an atmospheric source (e.g., due to venting). In some configurations, the vapor space of the internal volume 204 can be controlled by leaking the vessel 202 and providing controlled vacuum at the exhaust port 238 (e.g., as discussed above). In some configurations, the controller 260 may be implemented to automate a vent rate of a vessel to be proportionate to a flow rate for a given compound. A computer code for determining a vent rate of a vessel may be entered into a computer or the controller 260 and used to calculate the vent rate for a given product (e.g., a liquid or alcoholic beverage containing fermentation molecules).

In some configurations, the food processing system 200 can utilize molecular vapor saturation and diffusion gradients to decrease the volatility of molecules with relatively higher molecular weight (e.g. ethyl octanoate, 172 atomic mass units (AMU), etc.) and to enhance relative separation of molecules with relatively lower molecular weight (e.g. ethyl acetate, 88 AMU, etc.). For example, the vessel 202 can be configured to receive air to achieve gas equilibrium of a food or beverage and form a saturated vapor space within the internal volume 204, which can include a higher vapor pressure than an unsaturated vapor space. The molecules within the internal volume 204 can be separated by molecular weight, as relatively lighter molecules diffuse up to the gas separator 230. Accordingly, within the internal volume 204, the diffusion gradient of the relatively lighter molecules can be greater than the diffusion gradient of the relatively heavier molecules. The exhaust fan 240 can provide a pressure gradient that encourages a flow of gas (e.g., the relatively lighter molecules) to move from the gas separator 230 to the exhaust port 238. Thus, the gas separator 230 can provide a diffusion chamber to more selectively separate the relatively lighter molecules from the relatively heavier molecules.

With continued reference to FIG. 2, in some configurations, the exhaust gas can pass to the gas separator 230 without significantly disturbing the equilibrium vapor concentrations of molecules within the vessel 202 during operation. In contrast, operating the food processing system 200 at a higher leak rate can contribute to molecular saturation below 80% of the atmospheric saturation, for example, to limit formation of molecular diffusion gradients and evaporation of certain fermentation molecules

During flavor maturation, the dissolved gas content of the food or beverage during flavor maturation can be monitored and balanced to optimize smooth mouthfeel and accentuate flavor notes. Prior to flavor maturation, a plurality of sensors (e.g., a dissolved gas meter including a total dissolved gas meter, a dissolved CO₂ meter, a dissolved oxygen meter, or combinations thereof) can be used to determine equilibrium gas levels of the food or beverage. In some configurations, an inlet sensor 220 can be provided near the fluid inlet 210 to measure one or more levels of various parameters, including a ABV composition or concentrations of dissolved gas. In some configurations, the inlet sensor 220 can be in communication with the controller 260 to record measurements or control operations of one or more components of the food processing system 200 (e.g., an actuator valve for the fluid inlet 210).

In some configurations, the controller 260 can receive a user input for controlling the flavor maturation process. For example, the controller 260 can include an on/off button that allows an operator to initiate or terminate the flavor maturation process according to a predetermined set of parameters or results. For example, the controller 260 can receive information related to a composition of a dissolved gas, a concentration of a dissolved gas, a number of passes through the food processing system 200, pressure, temperature, etc.

Under flavor maturation, gas balance of the food or beverage can be disturbed, and the level of gas can decrease within the food or beverage. As shown in FIG. 2, the food or beverage can be further processed by introducing compressed gas to the food or beverage via a sparger 252. In some configurations, the sparger 252 can include a sparging stone or a diffusion stone (e.g., a sanitary diffusion stone). In some configurations, the sparger 252 can be located along a fluid outlet pipe downstream of the fluid outlet 212 or within the internal volume 204. A pump 250 can be in fluid communication with the fluid outlet 212 and the sparger 252 and provide pressure to pump the compressed gas into the food or beverage. The food or beverage can contact the compressed gas for a period of time to promote dissolution of the compressed gas within the food or beverage. A portion of the compressed gas can rise to a surface of the food or beverage within the internal volume 204 and be routed out of the internal volume 204 via the gas outlet 214. In some configurations, injecting the compressed gas into the vessel 202 under partial pressure (e.g., in a soft vacuum state) can cause shock and rapid oxidation in the food or beverage, resulting in an increased concentration of desired fermentation molecules over time during aging. The desired fermentation molecules can include acetaldehyde, ethyl acetate, acetaldehyde diethyl acetal, ethyl caproate, ethyl caprylate, ethyl decanoate, etc. Accordingly, using the sparger 252 can enhance the flavor maturation process in the food or beverage within the vessel 202 and provide a balanced flavor profile of the matured food or beverage.

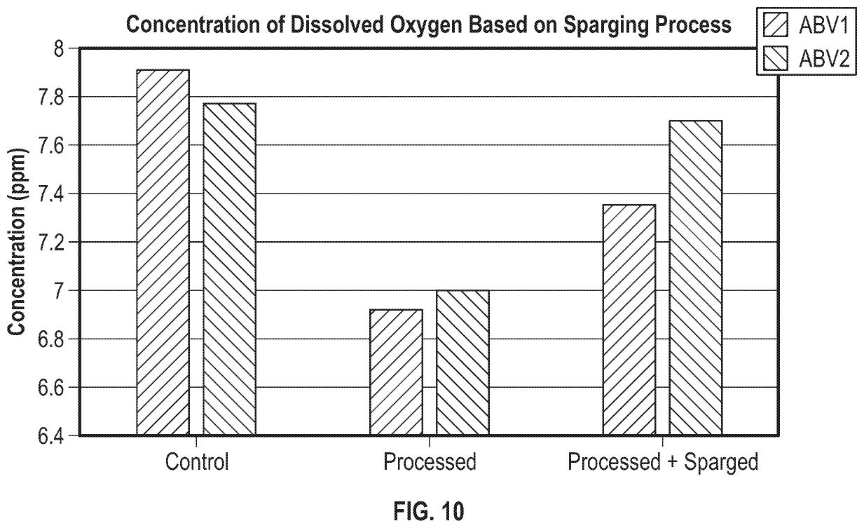

In some configurations, the operation of the pump 250 or the sparger 252 can be controlled based on measurements from a plurality of sensors, including an outlet sensor 222. In some configurations, the outlet sensor 222 can measure one or more levels of various parameters, including a ABV composition or concentrations of dissolved gas. In some configurations, the outlet sensor 222 can be in communication with the controller 260 to record measurements or control operations of one or more components of the food processing system 200. For example, an actuator valve for the fluid outlet 212, the pump 250, or the sparger 252 can be controlled to provide a desired composition or amount of compressed gas into the internal volume 204. Accordingly, a desired flavor profile can be achieved. In some embodiments, as also empirically shown in FIG. 10, a peak flavor of a food or beverage can be achieved by a level of gas returning to between 10% and 90% of a pre-processed level of gas, or between 25% and 75% of the pre-processed level of gas, or between 33% and 66% pre-processed level of gas.

In some configurations, the compressed gas may be air. In some configurations, the compressed gas may be a blend of nitrogen and CO₂, with CO₂ levels between 300 and 1500 parts per million (ppm). In some configurations, the compressed gas can be nitrogen-free air and include a level of CO₂ between 400 and 600 ppm. In some configurations, the compressed gas can be carbonated gas and include a level of CO₂ between 1,500 and 10,000 ppm.

In some configurations, an inlet pressure of the compressed gas may be between 10 and 200 pounds per square inch (PSI). In some configuration, the inlet pressure of the compressed gas can be at least 10 PSI higher than the hydrostatic pressure in the vessel 202 relative to atmosphere. In some configurations, dissolved gas levels within the internal volume 204 may return to between one-quarter to three-quarters, such as between one-third to two-thirds of the atmospheric levels to maximize balance of flavor and mouthfeel. In some configurations, the compressed gas may be reintroduced into the internal volume 204 via an atmospheric pressure open air liquid cascade or waterfall.

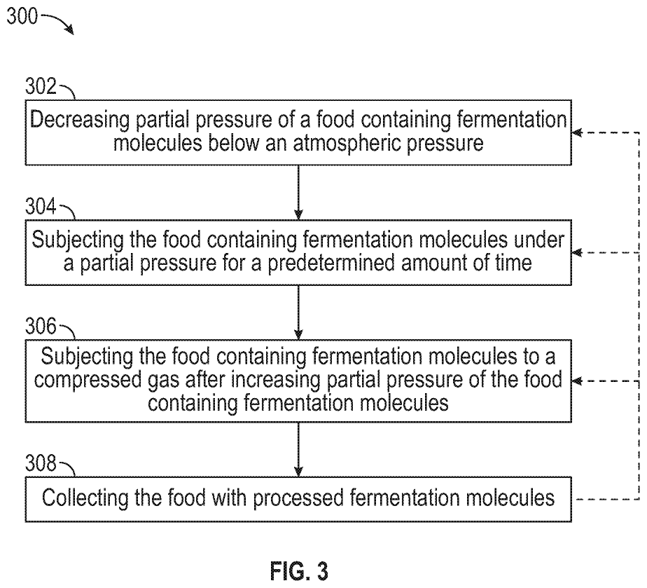

FIG. 3 illustrates a non-limiting method 300 for processing fermentation molecules in a food or beverage, in accordance with some embodiments. The method 300 may be implemented using a food processing system such as the food processing system 200 of FIG. 2. At process block 302, a food or beverage containing fermentation molecules can enter a vessel of a food processing system, which can decrease partial pressure of the food to below an atmospheric pressure. For example, the partial pressure of the food can be between about 150 Torr and about 650 Torr, between about 300 Torr and about 550 Torr, between about 350 Torr and about 500 Torr, between about 150 Torr and about 450 Torr. The food or beverage can enter the vessel by forming a high surface area liquid. For example, the food or beverage can be sprayed, percolated, or flown into an internal volume of the vessel at a predetermined flow rate. In some configurations, the vessel can include a plurality of trays that the food or beverage can travel through the internal volume (e.g., similar to a waterfall or in a cascading manner).

At process block 304, the food or beverage can be subjected to the partial pressure environment for a predetermined amount of time. The vessel can be a relatively low-pressure condition. The vessel may be maintained as a leaky vessel, where a controlled amount of atmospheric gas may enter through a vent valve or other controlled openings (e.g., to increase partial pressure of the food or beverage containing fermentation molecules). The controlled leakage may help to maintain a desired pressure level and gas composition within the chamber. In some configurations, the leaky vessel can help to create a diffusion gradient in the gas composition within the chamber.

As the food or beverage is exposed to the partial pressure environment, fermentation molecules may evaporate from the liquid. These evaporated molecules may accumulate in a headspace of the internal volume. Over time, the headspace can become saturated with various volatile compounds, and a concentration gradient between the liquid and gas phases can be created. The saturated headspace may contain a mixture of different molecules, including ethyl acetate, ethanol, and other fermentation byproducts. In some configurations, the molecules can have different molecular weights and volatilities.

At block 304, the gas molecules with different molecular weights can be separated based on physical properties (e.g., molecular weight) via a gas separator. In some configurations, the gas separator may include features such as a series of baffles, expanded sections, or temperature gradients that may enhance molecular separation. Heavier molecules may tend to settle or condense in certain areas of the gas separator or within the internal volume, while lighter molecules can flow towards an exhaust fan. In some configurations, the gas molecules can pass through a filter (e.g., at an inlet of the gas separator or an exhaust port by the exhaust fan), which can enhance the molecule diffusion process. Accordingly, the molecular separation process may allow for selective removal of specific compounds from the food or beverage, potentially improving its flavor profile.

In some configurations, the duration of exposure to the partial pressure environment and the rate of gas flow through the gas separator may be adjusted to achieve desired levels of molecular separation and flavor modification. In some configurations, the food or beverage can pass through the vessel or gas separator multiple times to further refine the composition of the food or beverage. For example, an additional vessel can be arranged in parallel with the main vessel to process multiple batches of food or beverage simultaneously, or in series with the main vessel to subject the food or beverage to sequential processing stages.

At process block 306, the food or beverage containing fermentation molecules can be subjected to a compressed gas, for example, after increasing partial pressure of the food or beverage. In some configuration, the compressed gas may be introduced via a sparger located in a fluid outlet tube or within the internal volume of the vessel. In some configurations, the sparging process can include introducing compressed gas into the food or beverage through a sparger, which may be a porous device, diffuser, or a sparging stone that creates small bubbles. As these bubbles rise through the food or beverage, the bubbles can facilitate the transfer of gas molecules into the food or beverage. In some configurations, the sparger can provide the compressed gas from various locations within the vessel or in a separate vessel connected to the main vessel. As the gas bubbles through the food or beverage, the gas may dissolve into the food or beverage, and the gas composition of the food or beverage can be changed.

Further, at block 306, excess gas and volatile compounds may accumulate in the headspace of the vessel. The gas mixture can be directed towards a gas outlet of the vessel to be removed from the headspace. At process block 308, the food with the processed fermentation molecules can be collected. In some configurations, the food can pool at a bottom of the vessel or removed through a pump (e.g., mechanical pumping). In some configurations, any one of the block 302, the block 304, the block 306, and the block 308 can be repeated to control or adjust fermentation molecules in a food for multiple times (e.g., between two to five times). In some configurations, any one of the block 302, the block 304, the block 306, and the block 308 can be repeated to control or adjust fermentation molecules in a food by serially or parallelly connecting a multiple number of flavor balancing units (e.g., between two to five flavor balancing units).

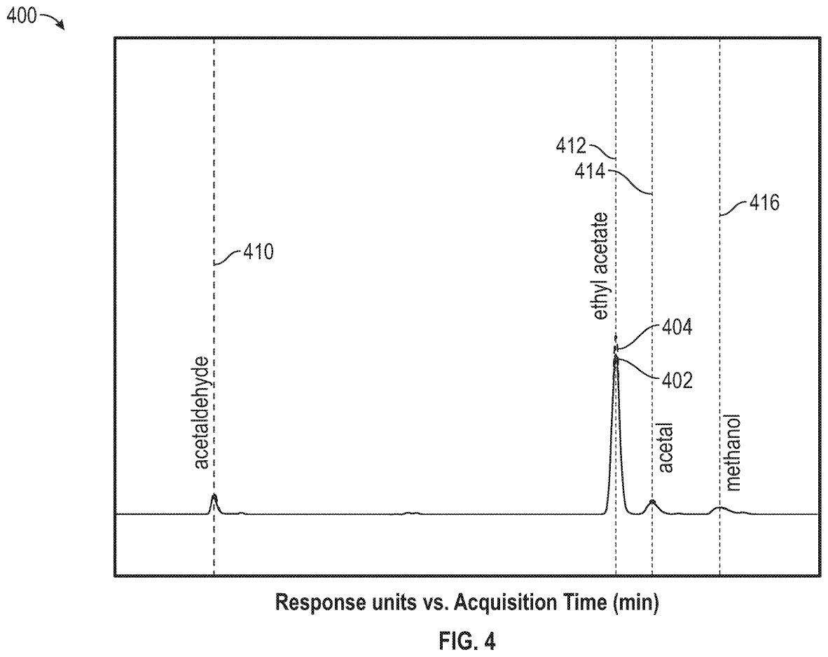

FIGS. 4-9 illustrate non-limiting sets of example data of concentration of molecules in a food or beverage that was processed using a flavor maturation process as described above (e.g., such as the method 300). The example data was obtained from gas chromatography analysis of the example beverage, where contents of compounds were measured at particular retention times. Each retention time corresponds to a specific compound based on physical and chemical properties of the compound. In the plots of FIGS. 4-9, line 402 illustrates the content of molecules before flavor maturation, and line 404 illustrates the content of molecules after flavor maturation.

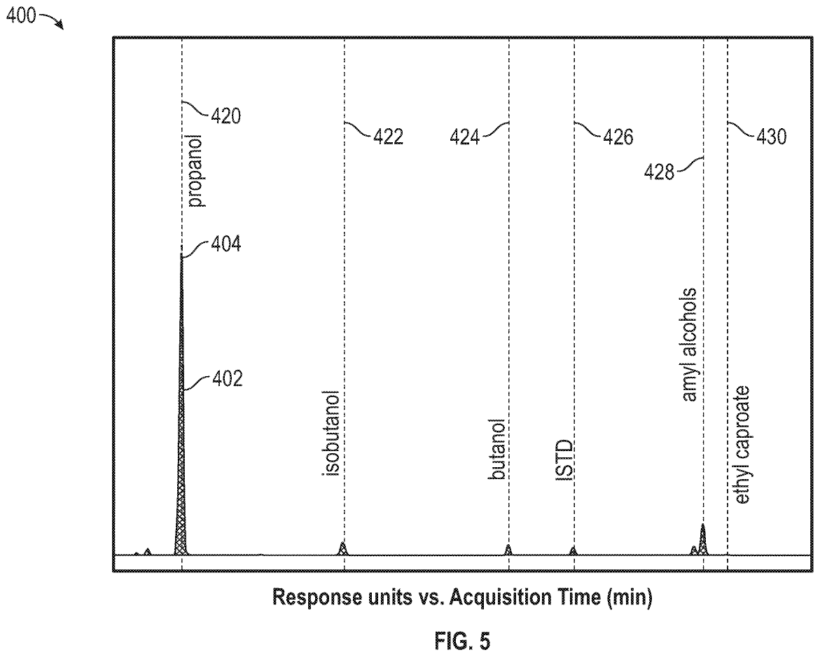

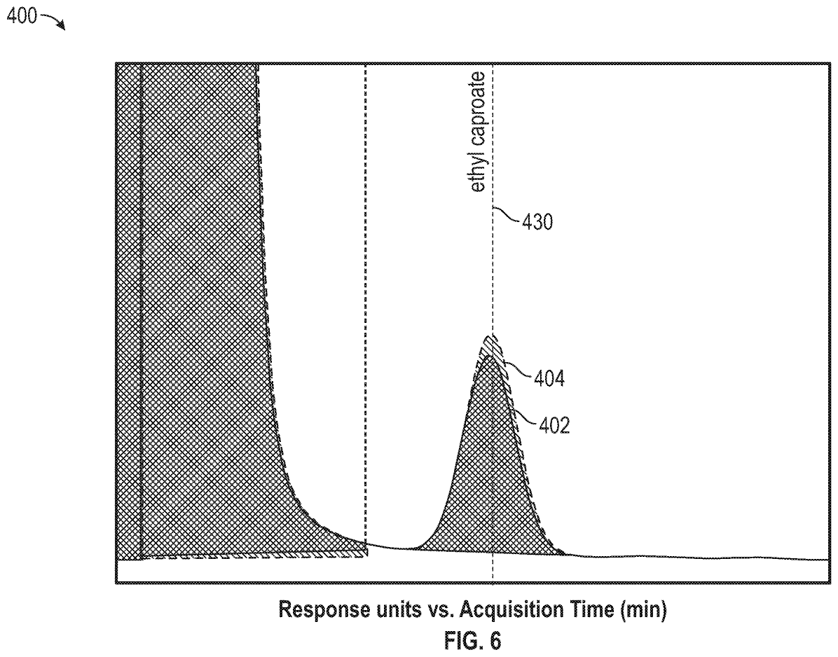

With reference to FIG. 4, a concentration of acetaldehyde was measured at a first retention time 410, a concentration of ethyl acetate was measured at a second retention time 412, a concentration of acetal was measured at a third retention time 414, and a concentration of methanol was measured at a fourth retention time 416. With reference to FIG. 5, a concentration of propanol was measured at a fifth retention time 420, a concentration of isobutanol was measured at a sixth retention time 422, a concentration of butanol was measured at a seventh retention time 424, and an internal standard (ISTD) was measured at an eighth retention time 426 for calibration verification. Further, a concentration of amyl alcohols was measured at a ninth retention time 428, and a concentration of ethyl caproate was measured at a tenth retention time 430. FIG. 6 is a detailed view of the concentrations of ethyl caproate as measured at the tenth retention time 430.

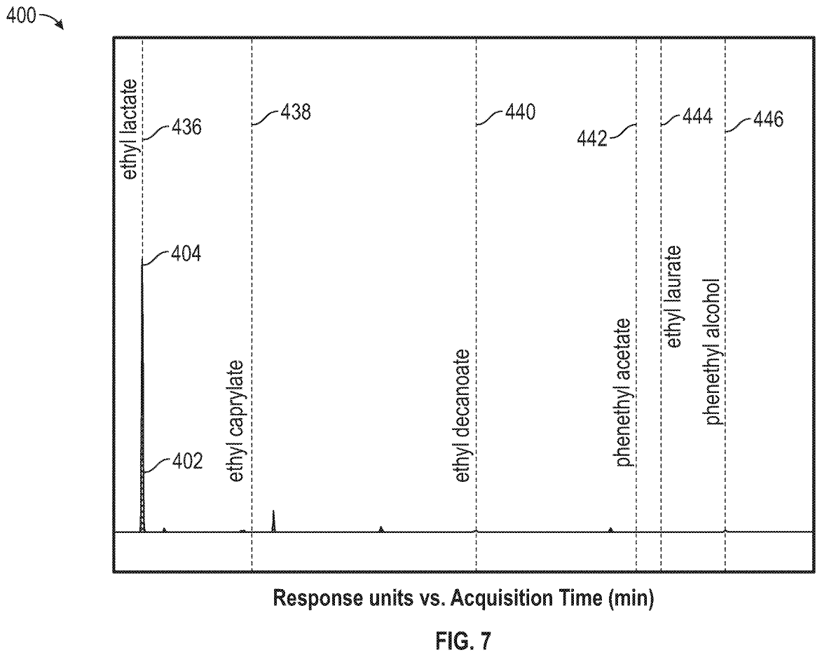

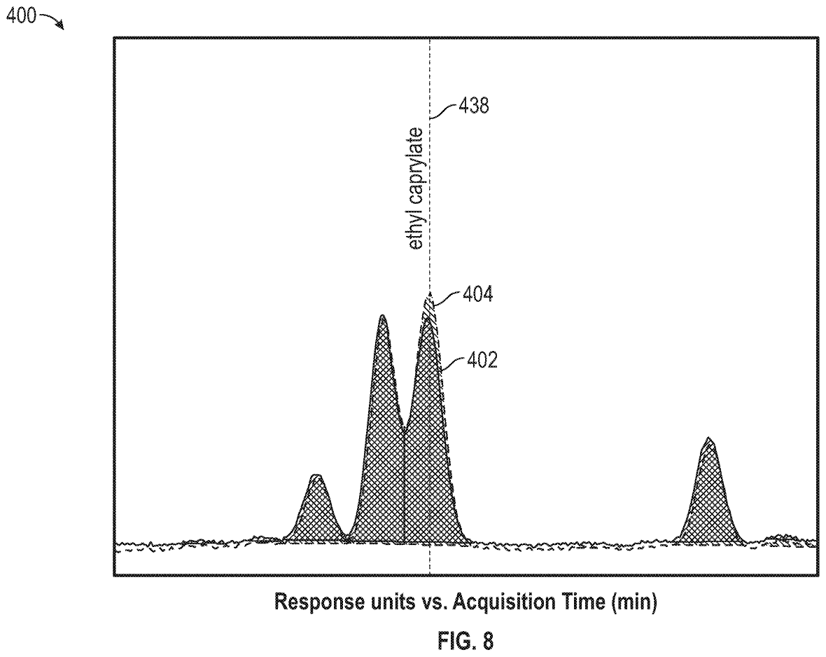

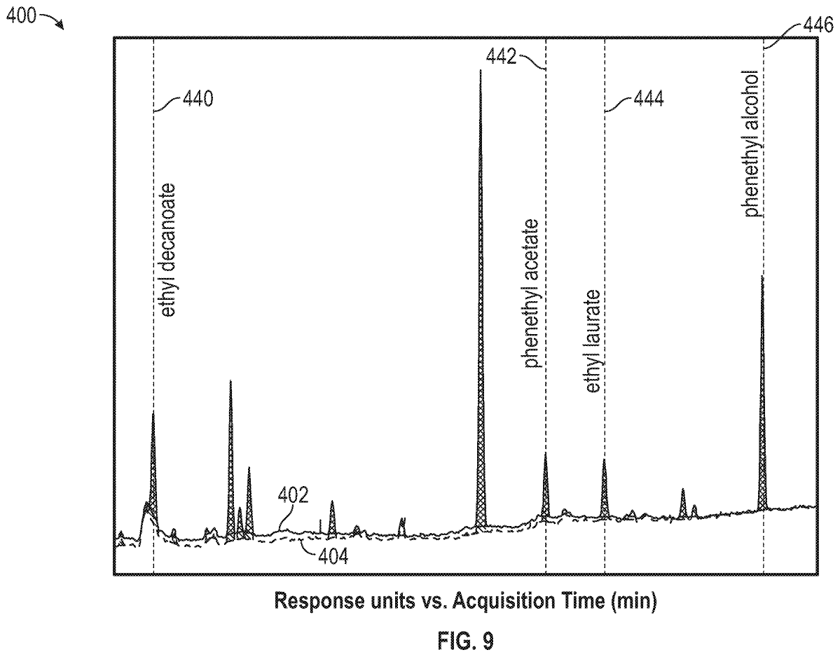

With reference to FIG. 7, a concentration of ethyl lactate was measured at an eleventh retention time 436, a concentration of ethyl caprylate was measured at a twelfth retention time 438, a concentration of ethyl decanoate was measured at a thirteenth retention time 440, a concentration of phenethyl acetate was measured at a fourteenth retention time 442, a concentration of ethyl laurate was measured at a fifteenth retention time 444, and a concentration of phenethyl alcohol was measured at a sixteenth retention time 446. FIG. 8 is a detailed view of the concentrations of ethyl caprylate as measured at the twelfth retention time 438. FIG. 9 is a detailed view of the concentrations of ethyl decanoate as measured at the thirteenth retention time 440, the concentrations of phenethyl acetate as measured at the fourteenth retention time 442, the concentrations of ethyl laurate as measured at the fifteenth retention time 444, and the concentrations of phenethyl alcohol as measured at the sixteenth retention time 446.

The experimental data illustrated in FIGS. 4-9 is shown in Table 1 below.

TABLE 1
Results of rate of change in concentrations
of molecules in a sample beverage

| | Before | After | |
|---|---|---|---|
| Compound | (ppm) | (ppm) | % change |
| Acetaldehyde | 1105.79 | 1294.88 | 17.10 |
| Ethyl Acetate | 5179.77 | 6142.47 | 18.59 |
| Acetal | 137.02 | 170.41 | 24.37 |
| Methanol | 468.19 | 450.5785 | −3.76 |
| Propanol | 10748.16 | 10993.37 | 2.28 |
| Isobutanol | 497.85 | 522.17 | 4.89 |
| Isoamyl Acetate | 0.0017 | 0.0016 | −5.88 |
| Butanol | 317.29 | 313.68 | −1.14 |
| Active Amyl Alcohol | 275.65 | 282.44 | 2.46 |
| Isoamyl Alcohol | 946.66 | 939.3 | −0.78 |
| Ethyl Caproate | 26.88 | 30.7 | 14.21 |
| Ethyl Lactate | 3907.49 | 3539.95 | −9.41 |
| Ethyl Caprylate | 7.99 | 9.41 | 17.77 |
| Ethyl Decanoate | 6.61 | 7.14 | 8.02 |
| Phenethyl Acetate | 2.77 | 2.42 | −12.64 |
| Ethyl Laurate | 3.84 | 4.17 | 8.59 |
| Phenethyl Alcohol | 6.13 | 5.37 | −12.40 |

As indicated by the change in the concentration of compounds in the processed example beverage, the flavor maturation process significantly affected the concentration of various fermentation molecules. For example, acetaldehyde increased in concentration from 1105.79 ppm to 1294.88 ppm, representing a 17.10% increase. Ethyl acetate showed a substantial increase in concentration from 5179.77 ppm to 6142.47 ppm, corresponding to an 18.59% increase. Similarly, acetal concentration rose from 137.02 ppm to 170.41 ppm, demonstrating a 24.37% increase. The flavor maturation process also affected ester compounds, for example, by assisting the formation of esters in the example beverage. For example, ethyl caproate increased from 26.88 ppm to 30.7 ppm (e.g., a 14.21% increase), ethyl caprylate increased from 7.99 ppm to 9.41 ppm (e.g., a 17.77% increase), and ethyl decanoate increased from 6.61 ppm to 7.14 ppm (e.g., an 8.02% increase). Accordingly, the experimental data supports that the disclosed flavor maturation process increased concentrations of select fermentation molecules by subjecting the fermentation molecules to reduced partial pressure and immediately injecting sparging air to cause shock and rapid oxidation in the sample alcohol.

Referring to FIG. 10, a set of graphs shows a concentration of dissolved oxygen gas in a food or beverage that was processed using a sparging process as described above (e.g., such as the block 406 of the method 400). In particular, data was recorded for the beverage including a first level of ABV concentration (“ABV1”) and the beverage including a second level of ABV concentration (“ABV2”). In the experiment, the ABV1 was greater than the ABV2, and a pressure condition for the beverage group including ABV1 was greater than the beverage group including ABV2. A gas separator was not used to collect the data shown in FIG. 8. For the beverage group including ABV1, the beverage under a control condition included 7.91 ppm of dissolved gas, the beverage under a flavor maturation process without sparging included 6.92 ppm of dissolved gas, and the beverage under a flavor maturation process with sparging included 7.35 ppm of dissolved gas. For the beverage group including ABV2, the beverage under a control condition included 7.77 ppm of dissolved gas, the beverage under a flavor maturation process without sparging included 7.00 ppm of dissolved gas, and the beverage under a flavor maturation process with sparging included 7.70 ppm of dissolved gas. Thus, the beverages under the flavor maturation process and sparging resulted in the highest concentrations of dissolved gas than the beverages under the flavor maturation process without sparging. Further, the beverage including ABV2 resulted in a higher concentration of dissolved gas than the beverage including ABV1.

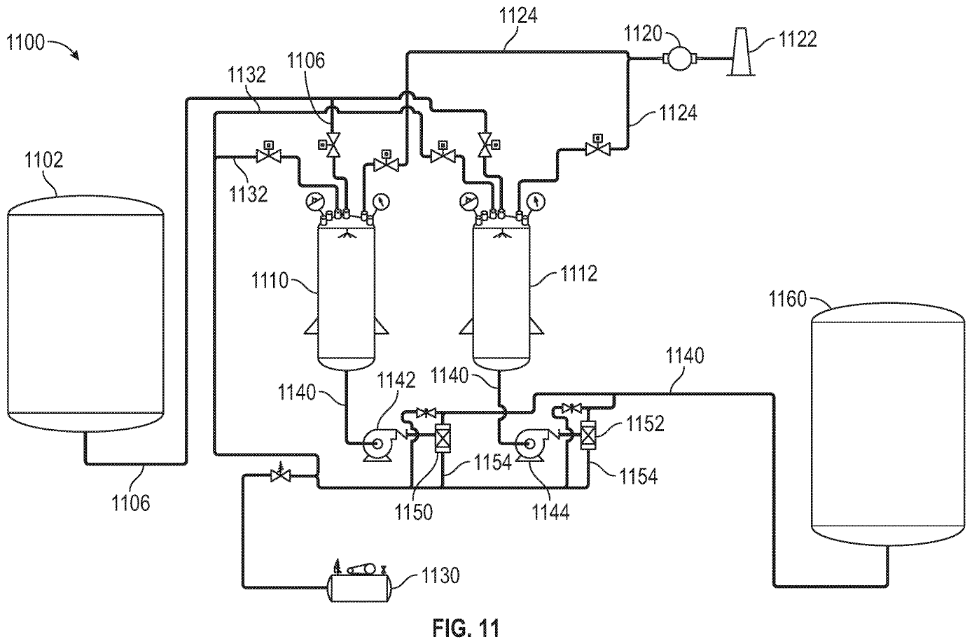

FIG. 11 illustrates a food processing system 1100 according to one configuration of the present disclosure. The food processing system 1100 is a particular example of the food processing system 100 of FIG. 1 and the food processing system 200 of FIG. 2 and includes aspects that are similar to those food processing systems. For the sake of brevity, these common features will not be again described below in detail. Rather, previous discussion of commonly named or numbered features, unless otherwise indicated, also applies to example configurations of the food processing system 1100. However, in some aspects, the food processing system 1100 differs from the food processing system 100 and the food processing system 200, including regarding providing multiple processing chambers.

In particular, the food processing system 1100 includes a preliminary holding vessel 1102 that is configured to hold a food or beverage to be processed. The preliminary holding vessel 1102 is in fluid communication with a first processing chamber 1110 and a second processing chamber 1112 via a pre-maturation product path 1106. The pre-maturation product path 1106 can selectively route the food or beverage from the preliminary holding vessel 1102 to the first processing chamber 1110 and the second processing chamber 1112 for flavor maturation processing. In the illustrated example, the first processing chamber 1110 and the second processing chamber 1112 are arranged in parallel. In some configurations, arranging the first processing chamber 1110 and the second processing chamber 1112 in parallel can increase processing capacity, for example, by processing multiple batches of the food or beverage simultaneously, or by providing alternating batch processing operations. In some configurations, the first processing chamber 1110 and the second processing chamber 1112 can operate under different processing conditions, including pressure, temperature, and humidity, to provide processing flexibility or to achieve a desired flavor profile.

With continued reference to FIG. 11, the food processing system 1100 includes a vacuum pump 1120 and an exhaust outlet 1122 that are arranged along an exhaust path 1124. The vacuum pump 1120 can provide a partial vacuum in the first processing chamber 1110 and the second processing chamber 1112 at a desired pressure level and promote gas separation of fermentation molecules released from the food or beverage. The released fermentation molecules can be directed toward the exhaust outlet 1122 via the exhaust path 1124. In some configurations, the pressure level of each of the first processing chamber 1110 and the second processing chamber 1112 can be between about 10 Torr and about 200 Torr, or between about 20 Torr and about 100 Torr.

The food processing system 1100 further includes an air compressor 1130 that is in fluid communication with the first processing chamber 1110 and the second processing chamber 1112 via a vent path 1132. The air compressor 1130 can provide compressed, filtered, and dry air into the first processing chamber 1110 and the second processing chamber 1112 to provide a leaky vessel environment. In some configurations, the vent path 1132 can regulate the atmospheric makeup within the processing chambers during continuous operation. As discussed above, the leaky vessel environment can create a saturated vapor space within the first processing chamber 1110 and the second processing chamber 1112. In some configurations, the saturated vapor space can decrease the volatility of heavier fermentation molecules and enhance selective separation of lighter fermentation molecules from the heavier fermentation molecules during the flavor maturation process.

Referring to FIG. 11, the food or beverage can exit the first processing chamber 1110 and the second processing chamber 1112 along respective post-maturation product paths 1140. A first product pump 1142 and a second product pump 1144 can provide pressure to route the food or beverage from the first processing chamber 1110 and the second processing chamber 1112, respectively, to downstream components.

In some configurations, the food or beverage exiting the first processing chamber 1110 can be sparged with compressed gas via a first sparger 1150, and the food or beverage exiting the second processing chamber 1112 can be sparged with compressed gas via a second sparger 1152. In some examples, the first sparger 1150 and the second sparger 1152 can each include a sparging stone or a diffusion stone. In particular, the air compressor 1130 can supply compressed gas to the first sparger 1150 and the second sparger 1152 along a sparging path 1154. The first sparger 1150 and the second sparger 1152 can introduce compressed gas into the food or beverage to cause shock and rapid oxidation, resulting in an increased concentration of desired fermentation molecules over time during aging. Although the illustrated example shows separate spargers for each processing chamber, other configurations can include a single sparger for sparging the processed food or beverage from both the first processing chamber 1110 and the second processing chamber 1112. The processed food or beverage can be routed to a post-processing holding vessel 1160 via the post-maturation product path 1140 for storage or further downstream processing.

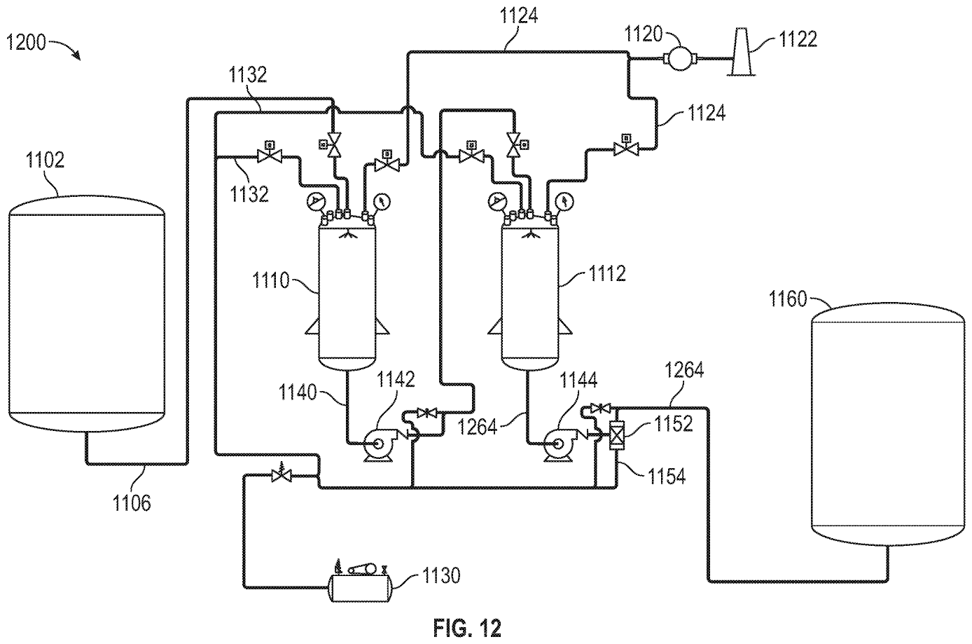

FIG. 12 illustrates another embodiment of a food processing system 1200 having the first processing chamber 1110 and the second processing chamber 1112 as disclosed herein. The food processing system 1200 includes like elements and numerals as the food processing system 1100 described above with respect to FIG. 11. However, in some aspects, the food processing system 1200 differs from the food processing system 1100. In particular, the first processing chamber 1110 and the second processing chamber 1112 are arranged in series rather than in parallel. Accordingly, the food or beverage can be processed in the first processing chamber 1110 and subsequently routed to the second processing chamber 1112 via the post-maturation product path 1140, which is configured as a first post-maturation product path, to achieve the food or beverage having twice-processed fermentation molecules. In the illustrated configuration, the single sparger 1152 is provided at an outlet of the second processing chamber 1112 for sparging the food or beverage having the twice-processed fermentation molecules along a second-post maturation product path 1264. The sparged food or beverage can be routed to the post-processing holding vessel 1160 via the second post-maturation product path 1264.

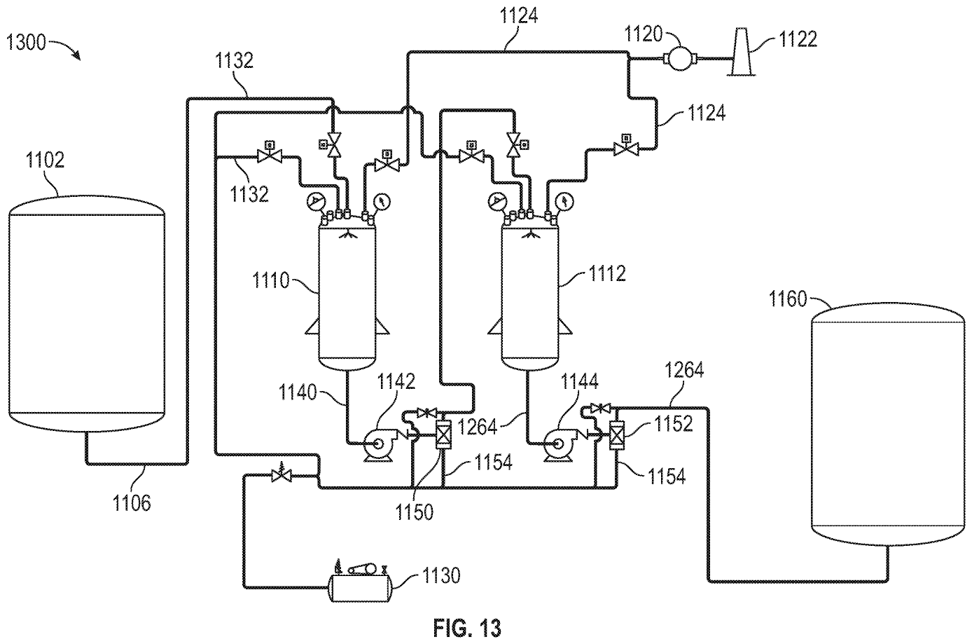

FIG. 13 illustrates another embodiment of a food processing system 1300 having the first processing chamber 1110 and the second processing chamber 1112 as disclosed herein. The food processing system 1300 includes like elements and numerals as the food processing system 1200 described above with respect to FIG. 12. However, in some aspects, the food processing system 1300 differs from the food processing system 1200. In particular, the food processing system 1300 includes the first sparger 1150 at an outlet of the first processing chamber 1110 and the second sparger 1152 at an outlet of the second processing chamber 1112. Accordingly, the food or beverage can be sparged after exiting each of the first processing chamber 1110 and the second processing chamber 1112, which can provide flexibility in adjusting dissolved gas levels between processing stages.

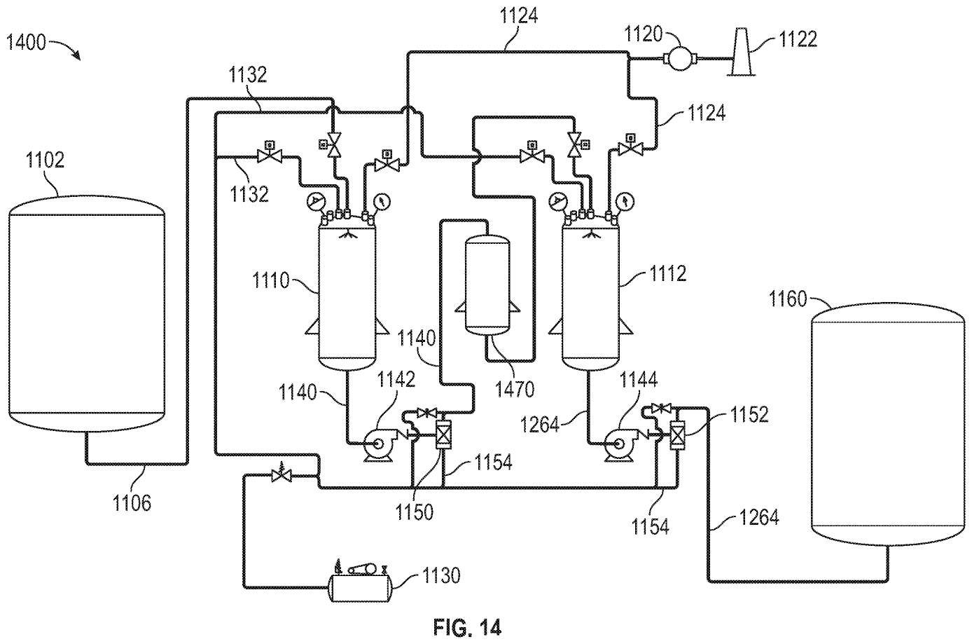

FIG. 14 illustrates another embodiment of a food processing system 1400 having the first processing chamber 1110 and the second processing chamber 1112 as disclosed herein. The food processing system 1400 includes like elements and numerals as the food processing system 1300 described above with respect to FIG. 13. However, in some aspects, the food processing system 1400 differs from the food processing system 1300. In particular, the food processing system 1400 includes a pressure management system 1470 between the first processing chamber 1110 and the second processing chamber 1112 to isolate the respective pressure conditions. In some configurations, the pressure management system 1470 is positioned along the first post-maturation product path 1140 between the first processing chamber 1110 and the second processing chamber 1112. In some configurations, the pressure experienced by the food or beverage in the first processing chamber 1110 can be less than the pressure experienced by the food or beverage in the second processing chamber 1112 to selectively control or adjust at least one of an amount or balance in the fermentation molecules in the food or beverage.

In some configurations, the pressure management system 1470 can be configured as a buffer tank that includes a buffer tank pressure higher than the pressure experienced by the food in the first processing chamber 1110. In some configurations, the buffer tank pressure can be a positive pressure. In some configurations, the pressure management system 1470 can be maintained at a pressure between about 300 Torr and about 760 Torr. Therefore, the pressure management system may allow for a controlled transition from the higher-pressure environment (e.g., a first pressure setting) of the first processing chamber 1110 to the lower pressure environment (e.g., a second pressure setting) of the second processing chamber 1112, thereby providing staged flavor maturation with optimized processing conditions.

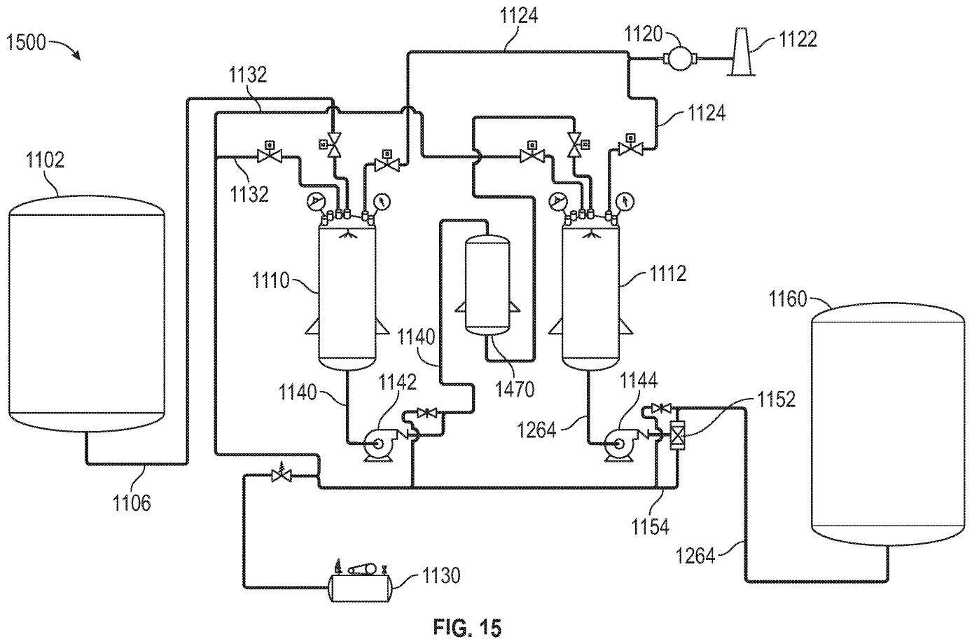

FIG. 15 illustrates a food processing system 1500 having a first processing chamber 1110, a second processing chamber 1112, and a pressure management system 1470 as disclosed herein. The food processing system 1500 includes like elements and numerals as the food processing system 1400 described above with respect to FIG. 14. However, in some aspects, the food processing system 1500 differs from the food processing system 1400. In particular, the food processing system 1500 includes the single sparger 1152 at an outlet of the second processing chamber 1112 rather than separate spargers for each of the first processing chamber 1110 and the second processing chamber 1112. Accordingly, the food or beverage can be sparged after processing in both the first processing chamber 1110 and the second processing chamber 1112 is complete, resulting in the food or beverage having twice-processed fermentation molecules with a desired flavor maturation profile. The sparged food or beverage can be routed to the post-processing holding vessel 1160 via the second post-maturation product path 1264.

It is to be understood that the disclosed technology is not limited in its application to the details of construction and the arrangement of components set forth in the following description or illustrated in the following drawings. The disclosed technology is capable of other aspects and of being practiced or of being carried out in various ways. Also, it is to be understood that the phraseology and terminology used herein is for the purpose of description and should not be regarded as limiting.

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean up to plus or minus 10% of the particular term and “substantially” and “significantly” will mean more than plus or minus 10% of the particular term.

The phrase “such as” should be interpreted as “for example, including.” Moreover, the use of any and all exemplary language, including but not limited to “such as”, is intended merely to better illuminate the disclosed technology and does not pose a limitation on the scope of the disclosed technology unless otherwise claimed. As used in this specification and the claims, the singular forms “a,” “an,” and “the” include plural forms unless the context clearly dictates otherwise.

Furthermore, in those instances where a convention analogous to “at least one of A, B and C, etc.” is used, in general such a construction is intended in the sense of one having ordinary skill in the art would understand the convention (e.g., “a system having at least one of A, B and C” would include but not be limited to systems that have A alone, B alone, C alone, A and B together, A and C together, B and C together, and/or A, B, and C together.). It will be further understood by those within the art that virtually any disjunctive word and/or phrase presenting two or more alternative terms, whether in the description or figures, should be understood to contemplate the possibilities of including one of the terms, either of the terms, or both terms. For example, the phrase “A or B” will be understood to include the possibilities of “A” or “B” or “A and B.”

All language such as “up to,” “at least,” “greater than,” “less than,” and the like, include the number recited and refer to ranges which can subsequently be broken down into ranges and subranges. A range includes each individual member. Thus, for example, a group having 1-3 members refers to groups having 1, 2, or 3 members. Similarly, a group having 6 members refers to groups having 1, 2, 3, 4, or 6 members, and so forth.

The modal verb “may” refers to the preferred use or selection of one or more options or choices among the several described configurations or features contained within the same. Where no options or choices are disclosed regarding a particular configuration or feature contained in the same, the modal verb “may” refers to an affirmative act regarding how to make or use an aspect of a described configuration or feature contained in the same, or a definitive decision to use a specific skill regarding a described configuration or feature contained in the same. In this latter context, the modal verb “may” has the same meaning and connotation as the auxiliary verb “can.”

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In some implementations, devices or systems disclosed herein can be utilized, manufactured, or treated using methods embodying aspects of the disclosed technology. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing or utilizing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as configurations of the disclosed technology, of the utilized features and implemented capabilities of such device or system.

The foregoing discussion is presented to enable a person skilled in the art to make and use configurations of the disclosed technology. Various modifications to the illustrated configurations will be readily apparent to those skilled in the art, and the generic principles herein can be applied to other configurations and applications without departing from configurations of the disclosed technology. Thus, configurations of the disclosed technology are not intended to be limited to configurations shown, but are to be accorded the widest scope consistent with the principles and features disclosed herein. The following detailed description is to be read with reference to the figures, in which like elements in different figures have like reference numerals. The figures, which are not necessarily to scale, depict selected configurations and are not intended to limit the scope of configurations of the disclosed technology. Skilled artisans will recognize the examples provided herein have many useful alternatives and fall within the scope of configurations of the disclosed technology.

While various spatial and directional terms, such as top, bottom, lower, mid, lateral, horizontal, vertical, front, and the like may be used to describe examples of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Within this specification, configurations have been described in a way which enables a clear and concise specification to be written, but it is intended and will be appreciated that configurations may be variously combined or separated without parting from the disclosed technology. For example, it will be appreciated that all preferred features described herein are applicable to all aspects of the disclosed technology described herein.

Thus, while the disclosed technology has been described in connection with particular configurations and examples, the disclosed technology is not necessarily so limited, and that numerous other configurations, examples, uses, modifications and departures from the configurations, examples and uses are intended to be encompassed by the claims attached hereto. The entire disclosure of each patent and publication cited herein is incorporated by reference, as if each such patent or publication were individually incorporated by reference herein.

Various features and advantages of the disclosed technology are set forth in the following claims.

What is claimed is:

1. A system for controlling or adjusting fermentation molecules in a food or beverage, the system comprising:
a leaky vessel configured to receive the food or beverage including fermentation molecules;
a gas separator in fluid communication with the leaky vessel and configured to receive the fermentation molecules released from the food or beverage via a gas outlet port and selectively separate the fermentation molecules including a lighter molecular weight from the fermentation molecules including a heavier molecular weight;
at least one of a pressure control or a heating control system configured to change environmental parameters in the leaky vessel; and
a controller configured to control at least one of a temperature, a pressure, or a time experienced by the food or beverage in the leaky vessel to selectively control or adjust at least one of an amount or balance of the fermentation molecules in the food or beverage.

2. The system of claim 1 further comprising a sparger configured to provide a compressed gas to the food or beverage.

3. The system of claim 2, wherein the sparger is positioned within the leaky vessel or downstream of a fluid outlet of the leaky vessel.

4. The system of claim 1, wherein the gas separator extends upwardly from the leaky vessel.

5. The system of claim 1, wherein the gas separator includes a converging section and a diverging section.

6. The system of claim 1, wherein the gas separator includes a height that is between 2 inches and 36 inches.

7. The system of claim 1 further comprising a plurality of filters downstream or upstream of the gas separator.

8. The system of claim 1 further comprising an exhaust fan configured to provide a pressure differential that induces an airflow from the leaky vessel to an exhaust port.

9. The system of claim 1, wherein the leaky vessel is configured to receive air that replaces less than 20% of the released fermentation molecules within the leaky vessel.

10. The system of claim 1, wherein the controller includes an on/off button.

11. The system of claim 1 further comprising a plurality of trays configured to engage with the food or beverage within the leaky vessel.

12. The system of claim 1, wherein the leaky vessel is a first leaky vessel, and the system further includes a second leaky vessel that is arranged in parallel or in series with the first leaky vessel.

13. A method of controlling or adjusting fermentation molecules in a food or beverage, the method comprising:
positioning the food or beverage in a vessel;
controlling a leak rate of the vessel to subject the food or beverage to a saturated vapor space within the vessel; and
controlling at least one of a pressure or temperature experienced by the food or beverage in the vessel to selectively control or adjust at least one of an amount or balance of fermentation molecules in the food or beverage and achieve the food or beverage having processed fermentation molecules.

14. The method of claim 13 further comprising:
providing a diffusion gradient to remove fermentation molecules with relatively lighter molecular weights from the food or beverage.

15. The method of claim 14, wherein providing the diffusion gradient includes providing a pressure differential that directs a flow of gas out of the vessel.

16. The method of claim 13 further comprising:
subjecting a compressed gas to the food or beverage having processed fermentation molecules.

17. The method of claim 16, wherein subjecting the compressed gas includes providing the compressed gas at a pressure level that is at least 10 pounds per square inch (PSI) higher than a hydrostatic pressure in the vessel.

18. The method of claim 16, wherein subjecting the compressed gas includes providing air.

19. The method of claim 16, wherein subjecting the compressed gas includes providing a blend of nitrogen and CO₂.

20. The method of claim 19, wherein providing the blend of nitrogen and CO₂ includes providing a concentration of CO₂ between 300 parts per million (ppm) and 1500 ppm.

21. The method of claim 19, wherein providing the blend of nitrogen and CO₂ includes providing a concentration of CO₂ between 1,500 ppm and 10,000 ppm.

22. The method of claim 13, further comprising:
positioning the food or beverage having the processed fermentation molecules in a second vessel;
controlling a leak rate of the second vessel to subject the food or beverage having the processed fermentation molecules to a second saturated vapor space within the second vessel; and
controlling at least one of a pressure or temperature experienced by the food or beverage in the second vessel to selectively control or adjust at least one of an amount or balance of fermentation molecules in the food or beverage and achieve the food or beverage having twice-processed fermentation molecules.

23. A system for controlling or adjusting fermentation molecules in a food or beverage, the system comprising:
a plurality of leaky vessels configured to receive the food or beverage;
a sparger configured to provide a compressed gas to the food or beverage;
at least one of a pressure control or a heating control system configured to change environmental parameters in the plurality of leaky vessels; and
a controller configured to control at least one of a temperature, a pressure, or a time experienced by the food or beverage in the plurality of leaky vessels to selectively control or adjust at least one of an amount or balance of fermentation molecules in the food or beverage.

24. The system of claim 23 further comprising a gas separator in fluid communication with the plurality of leaky vessels and configured to receive the fermentation molecules released from the food or beverage via a gas outlet port and selectively separate the fermentation molecules based on molecular weight.

25. The system of claim 23, wherein the sparger includes one or more of a sparging stone or a diffusion stone.

26. The system of claim 23, wherein the sparger is located within an internal volume of the plurality of leaky vessels.

27. The system of claim 23, wherein the plurality of leaky vessels is in fluid communication with a fluid outlet pipe for discharging the food or beverage, and
wherein the sparger is located along the fluid outlet pipe.

28. The system of claim 23, wherein the plurality of leaky vessels includes a first leaky vessel and a second leaky vessel.

29. The system of claim 28, wherein the sparger is positioned at an outlet of at least one of the first leaky vessel or the second leaky vessel.

30. The system of claim 28, wherein the first leaky vessel and the second leaky vessel are arranged in series, and
wherein the sparger is positioned between the first leaky vessel and the second leaky vessel.
